(19) United States
(12) Patent Application Publication
(10) Pub. No.: US 2007/0031156 A1
(43) Pub. Date: Feb. 8, 2007

(54) Amplification of TTL RF oscillator signals with digital logic and power switching technology for CO2 laser RF power supplies

(76) Inventor: W. Shef Robotham JR., Burlington, CT (US)

Correspondence Address: STALLMAN & POLLOCK LLP, 353 SACRAMENTO STREET, SUITE 2200, SAN FRANCISCO, CA, 94111, US

(21) Appl. No.: 11/478,222

(22) Filed: Jun. 29, 2006

Related U.S. Application Data
(60) Provisional application No. 60/703,576, filed on Jul. 29, 2005.

(51) Int. Cl. H04B 10/04; H04B 10/12

(52) U.S. Cl. 398/182

(57) ABSTRACT

RF power can be delivered to excite the discharges of laser systems using a series of fast semiconductor switches arranged in an “H”-bridge configuration. Such a configuration can amplify the output of crystal controlled RF oscillators, using a low voltage power supply, thereby reducing the number of necessary amplification stages while obtaining the desired output at the necessary frequencies. A power amplifier operating in a high efficiency mode can serve as a switch, thereby converting a rounded signal produced by an RF transformer connected between arms of the H-bridge into a square-wave-like signal, while providing the necessary output power.

### RELATED APPLICATION

This application claims the benefit of U.S. Provisional Application No. 60/703,576, filed on Jul. 29, 2005, by W. S. Robotham, and titled “Amplification of TTL RF Oscillation Signals With Digital Logic And Power Switching Technology For CO₂ Laser RF Power Supplies.” U.S. Provisional Application No. 60/703,576 is hereby incorporated by reference herein in its entirety.

### TECHNICAL FIELD OF THE INVENTION

The present invention relates to power supplies and power switches, such as those used to drive the discharges of laser systems.

### BACKGROUND

It is well known that logic circuits are easier to design and manufacture, and occupy less space, than RF analog circuits. It is also well known that digital microelectronic chips are less expensive than analog chips.

The RF power supplies used to excite the discharges of CO₂ lasers presently utilize analog power devices and analog circuits that operate anywhere in the 13.56 MHz to 160 MHz region. The lower frequencies are used primarily in CO₂ lasers having free space mode resonators and larger diameter discharges. CO₂ lasers that use wave-guiding between two or four parallel sides of a long laser cavity structure, containing the discharge, use the higher frequency RF power supplies and have small separation between the electrodes (i.e., 1 mm or less). Higher RF frequency discharges are capable of operating at higher gas pressures (i.e., greater than 50 Torr) that have the advantage of providing higher power laser outputs for the same size laser.

Traditionally, developing a simple, low cost RF power source has been difficult in the low power amplifier chain. Obtaining crystal-controlled oscillator outputs in the 3-5 Watt range requires several gain stages that have a tendency to be unstable and, therefore, costly in a manufacturing environment.

### BRIEF DESCRIPTION OF THE DRAWINGS

FIG. 1 is a schematic diagram illustrating an active RF impedance transformation circuit that can be used in accordance with an embodiment of the present invention.

FIG. 2A-2D shows a series of timing sequences for “H” switch operation in accordance with an embodiment of the present invention.

FIG. 3 is a schematic diagram illustrating an embodiment of the digital logic controller of the FIG. 1 circuit.

FIG. 4 shows a series of timing sequences for the logic circuits of FIG. 3 digital logic controller.

FIG. 5 shows a series of plots for signals of the FIG. 3 digital logic controller.

### DETAILED DESCRIPTION OF THE INVENTION

Systems and methods in accordance with embodiments of the present invention overcome deficiencies in existing power devices. For example, a system in accordance with one embodiment of the invention utilizes fast semiconductor switches arranged in a power “H”-bridge configuration (also called a “power bridge”), capable of operation in the frequency ranges of interest, to provide efficient and low cost RF power to drive CO₂ laser discharges. An “H”-bridge switch or “power bridge” arrangement is used with the aid of digital logic chips to amplify the output of crystal controlled RF oscillators, such as commercially available transistor-transistor-logic (TTL) oscillators utilized in the computer industry, to reduce the number of analog RF amplification stages and achieve the desired output power to drive laser gas discharges. Such an approach can be utilized throughout the RF range used to excite CO₂ laser discharges.

A TTL oscillator, typically used as an RF oscillator in CO₂ laser RF power supplies, such as model OSC-XCO-52-D, puts out about 3 mW at 100 MHz. An H-bridge switch utilizing four model 74CBT3125 Buss Switch devices operating from a 5V dc supply can amplify the 3 mW output to approximately 56 mW. This amplification can eliminate one or two RF amplification stages in the RF power supply driving the discharge of a 100 W output CO₂ laser. The use of a MOSFET model L8701 preliminary amplifier increases the 56 mW output from the H-power bridge to 5 W. The use of another MOSFET amplifier stage (i.e., a Philip model BL:F177) increases the 5 W output to 100 W. The addition of two ST Microelectronics model SD2943 devices in push-pull operation can amplify the output power to 500 W of average output power (or 1000 W at 50% duty cycle). This is sufficient power to drive a 55 W average power output CO₂ waveguide laser.

As indicated above, the use of logic gates can provide numerous advantages over the use of analog circuits, including lower component cost, smaller size and fewer problems with spurious oscillation arising from the stray RF coupling normally associated with cascaded analog circuits. Using digital technology can also reduce the required RF shielding and separation between the RF electronic components, which results in smaller size RF electronic packaging for the RF supply. This advantage occurs because the low level amplification stages are operating in saturation, as opposed to linear gain operation.

All of these items are important considerations in the selection of RF power supplies used to drive the discharges of CO₂ lasers. The RF frequencies normally utilized for driving the discharges of CO₂ lasers are anywhere from 13.56 MHz to about 200 MHz. Of particular interest is the frequency range from 80-100 Mz for 30-500 W laser systems. The RF frequencies below 50 MHz are used to drive larger cross sectional area laser discharges that tend to operate at lower pressures than smaller cross sectional areas discharges, such as in wave-guide or slab laser discharges. Discharges associated with wave-guide or slab lasers tend to operate at higher gas pressures (i.e., greater than 50 Torr). Large cross-sectional area discharges normally are cooled by flowing the gas, while small cross-sectional area discharges are sealed-off and cooled by diffusion of the gas molecules, which eventually collide with the two cooled walls (i.e., for slab lasers) or 4 cooled walls (i.e., for wave-guide lasers). These cooled walls provide the wave-guiding of the radiation within the laser resonators. In wave-guiding lasers, the walls are in turn cooled by airflow or liquid flow.

As a rule of thumb, an RF excited, diffusion cooled, sealed-off CO₂ laser has about 10% efficiency. Consequently, a 1000 W output laser can require a 10,000 W RF power supply, while a 10 W output CO₂ laser can require a 100 W RF power supply. The amplification of 3 mW from the TTL oscillator to 10,000 W requires a gain of approximately 3.3 million and a gain of 33,000 for the 100 W lasers. Any reduction in the required analog RF amplification can reduce cost and thus be beneficial in the marketplace.

A further advantage of utilizing Buss Switches in a H-bridge power supply, in addition to the ability of utilizing digital logic devices to control RF switches, is that the output impedance of the TTL oscillator (i.e., 320 Ohms) is compatible with the input impedance of the digital logic circuits, thereby eliminating the need for impedance matching circuits between the output of the TTL oscillator and inputs of the RF amplifiers. The output impedance of the TTL oscillators generally is not compatible with the input impedance of high power FETS or CMOS devices. The input impedance of high power RF semiconductor amplifiers typically is a low impedance (i.e., below 50 ohm). The output impedance of the H-bridge is easily made compatible with the input impedance of these RF amplifiers.

A circuit in accordance with an embodiment of the present invention utilizes a combination of digital techniques to control a power H-bridge and an RF amplifier in order to obtain a conservative 5 W of output power at frequencies of interest in driving CO₂ laser discharges. Of particular interest is the ability of the H-bridge to operate at 13.56 MHz (i.e., an RF band assigned for industrial usage) up to approximately 150 MHz. The RF carrier is supplied by a conventional CMOS/TTL crystal oscillator that is passed through logic gates, causing the oscillator output to be turned on and off. Either continuous wave (CW) modulation or pulse width modulation of the laser discharge can then be implemented. The RF gating is performed using a family of logic chips, such as those utilized in the computer industry, that have rise and fall times commensurate with the desired RF output frequency.

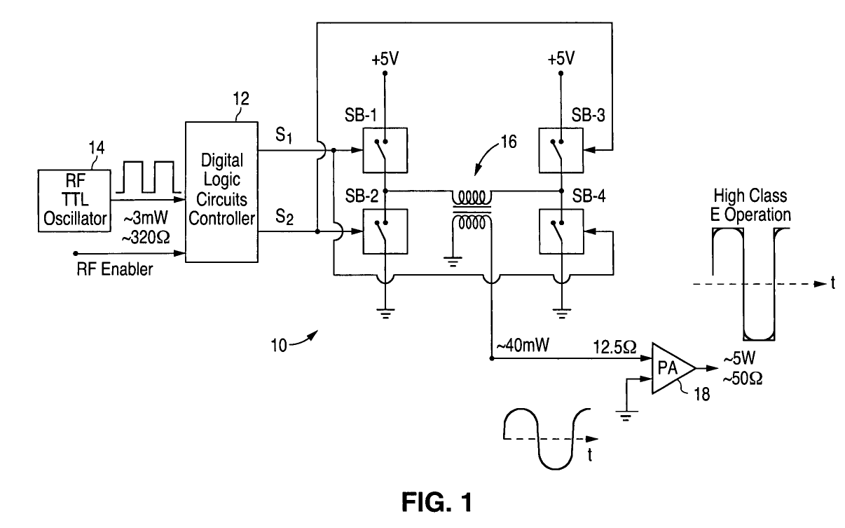

As discussed in greater detail below, an exemplary RF amplifier design uses computer Buss Switches that are configured in an “H” bridge that operates at a desired RF frequency, such as at 100 MHz. These Buss Switches are sufficiently fast to be useful up to 100 MHz and higher. In the FIG. 1 embodiment of the invention, the top left switch SB-1 and the bottom right switch SB-4 of the “H” bridge are turned on while the top right switch SB-3 and the bottom left switch SB-2 are turned off, and vice versa, at the RF carrier frequency. Activation in this manner causes the resulting bridge peak-to-peak output swing to be twice the voltage of the dc power supply. In one example, a 5V dc supply provides a 10V peak to peak. Additionally, the load impedance placed on the bridge can be significantly lower than a logic gate can tolerate, such as 50 Ohms verses 330 Ohms, respectively. Further, a step down transformer 16 can be used in the H-bridge to provide a closer impedance match to the typical VMOS or LDMOS transistors utilized for amplification to higher powers. With this topology, just a single stage of conventional RF gain can be used to obtain a 5-10 W output from a 3 mW input.

In at least some embodiments of the present invention, it is important to exercise care in component selection and PC board lay-out to match the switch drives, such that each switch in the bridge is turned on and off at the proper times. A ‘no output’ or similar state can be used to ensure that both sides of the bridge are off, preventing excess power consumption. A gating signal also can be applied to the gate of the RF amplifier to increase the gain of the stage when the carrier is “on” and cut off the device when the carrier is “off”, thereby further reducing the self-oscillation tendency of the unit.

The block diagram of FIG. 1 illustrates an exemplary RF H-bridge power circuit 10 with an associated logic circuit controller 12. In the FIG. 1 circuit arrangement, the four electronic Buss Switches SB-1, SB-2, SB-3 and SB-4 included in the H-bridge are represented in the form of mechanical switches in order to simplify the presentation of the basic operating principals of the invention.

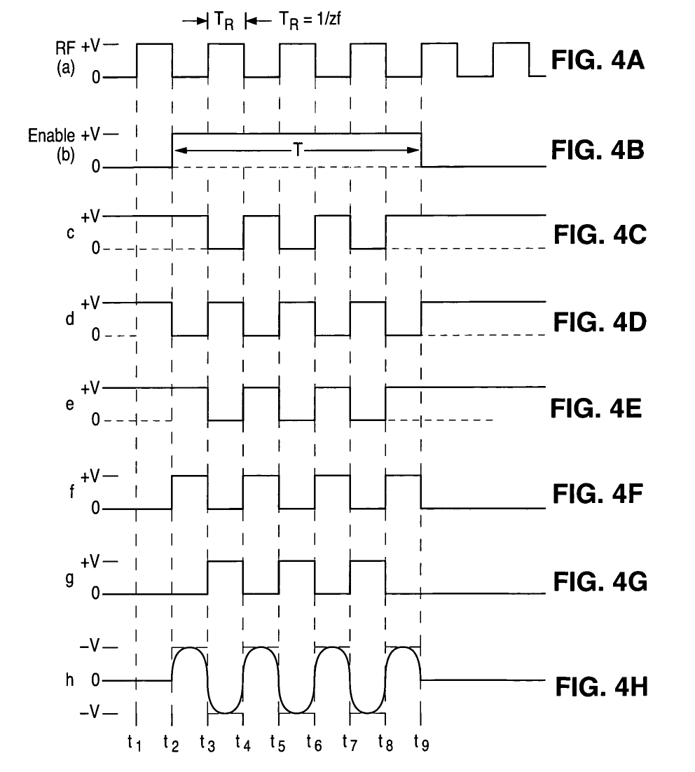

As shown in FIG. 1, the output of a crystal controlled TTL oscillator 14 is fed to the logic circuit controller 12. Typically, the oscillator 14 has an output of 3 mW and an impedance of approximately 320 Ohm at a specific RF frequency (such as at 100 MHz). One function of a logic circuit 12 such as that shown in FIG. 1 is to turn switches SB-1, SB-2, SB-3 and SB-4 on and off in the proper sequence, so as to draw current from the dc power supply in a manner to approximately reproduce the RF square wave from the TTL oscillator 14. The voltage out of the H-bridge 10 is approximately 10V (peak to peak) for a 5V dc power supply, which is common in digital technology. Those skilled in the art will appreciate that there are numerous known approaches for implementing the functions of the logic controller 12 using commercially available digital microelectronics circuits. Logic circuit controller 12 also has the capability of accepting an “enabler signal” that pulse-width modulates the input signal to the “H” switches, such that the output of the “H” switches is pulse-width modulated. Pulse width modulation is a commonly utilized technique for varying the average output power of a CO₂ laser by varying the average input power into the discharge from the RF power supply, as will be explained in greater detail below in conjunction with FIG. 4.

As discussed above, Buss Switches SB-1, SB-2, SB-3 and SB-4 are arranged in an “H” power bridge switch configuration, as shown in FIG. 1. An RF transformer 16 is connected as shown between switches SB-1/SB-2 and SB-3/SB-4. Upon the start of the first half cycle of the RF periodic wave from the TTL oscillator 14, the logic circuit 12 sends commands via signal S1 to close switches SB-1 and SB-4 of the H-bridge. This allows current to flow from the dc power supply (shown here as 5V) through switch SB-1, from left to right through the primary of the RF transformer 16, and then through switch SB-4 to ground. At the completion of the first positive half cycle of the RF square wave from the TTL oscillator 14 and the beginning of the first negative half cycle of the RF square wave, the logic circuit controller 12 commands switches SB-1 and SB-4 to open via signal S1 and then commands switches SB-3 and SB-2 to close via signal S₂. This process first stops current flow through the switch SB-1/transformer primary winding/switch BS-4 to ground path and then allows current to flow from the dc power supply through switch SB-3, from right to left through the primary winding of RF transformer 16 in FIG. 1 through switch SB-2 to ground. This action completes the first positive and negative portion of the RF square wave. The ratio of the number of windings between the primary winding and secondary winding of the transformer 16 offers the designer the ability to perform impedance matching to the pre-amplifier 18 of FIG. 1. As an example, the 320 Ohm output impedance of the TTL oscillator 14 in the FIG. 1 embodiment is transformed to a 12.5 Ohm impedance out of the transformer secondary winding of the “H” switch circuits, which is a reasonable match to the input impedance of the preliminary amplifier 18.

The transformer 16 tends to round off the corners of the square wave RF signal so that a distorted sinusoidal RF waveform is obtained to drive the preliminary RF amplifier 18 of FIG. 1. In an initial experiment, the average power out of the RF H-bridge 10 was found to be 56 mW. This power is sufficient to drive the preamplifier 18 of FIG. 1 in a high efficiency mode of non-linear amplification. In these experiments, an efficiency of approximately 70% was obtained in a class C mode of operation. With a class E mode of operation, approximately about 90% efficiency was found to be possible. A non-linear class of operation, therefore, is desirable since the efficiency and power output of power amplifiers (PA) is enhanced. Operating in a high efficiency mode enables the amplifier 18 to serve as a switch, thereby providing a square wave-like output and maximizing the efficiency of the stage. In addition to providing a power amplification for the TTL oscillator signal of 18.7 times, an impedance transformation of the 320 Ohms output of the TTL to 12.5 Ohms for the input of the amplifier 18 also can be provided.

As stated above, as general rule, CO₂ lasers have about 10% efficiency in converting RF power into laser power out. Consequently, a 500 W output CO₂ laser will require approximately 5000 W of RF power. To go from 3 mW to 5,000 W can require an analog RF gain of approximately 4.7 million. The “H” switch output of 56 mW can be used to reduce the required analog gain to approximately 89,000 if a 5V dc power supply and (e.g., 74CBT3125 model) Buss Switches are used to switch at a 100 MHz rate. Even better performance in gain can be obtained at lower frequencies. Starting with the 5 W output from the amplifier 18, an additional gain of 1000 is needed after the amplifier 18 of FIG. 1 to achieve a 5,000 W output.

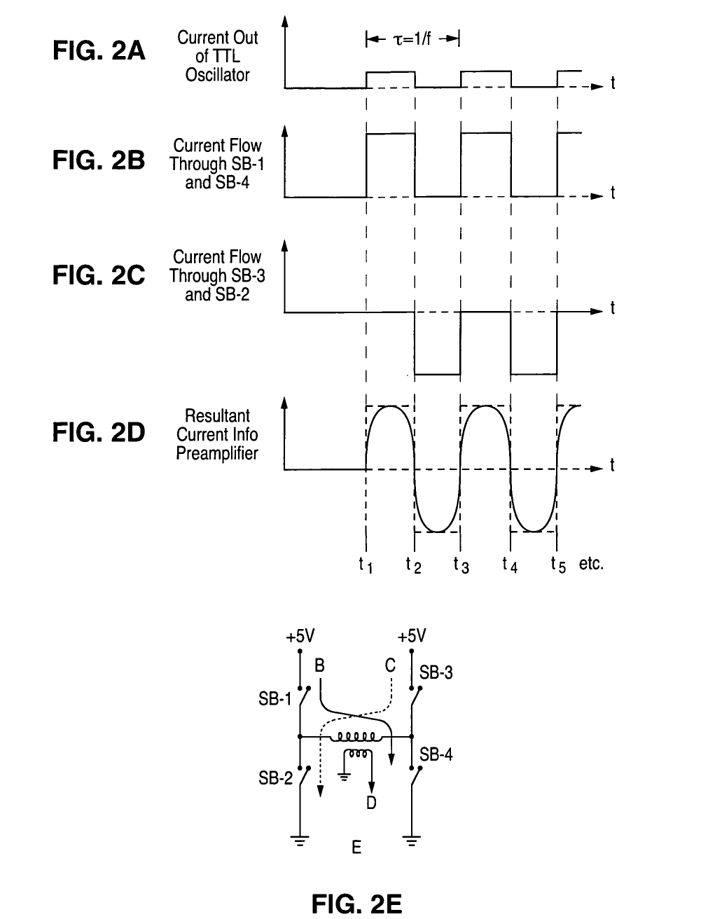

FIGS. 2A-2D illustrate exemplary basic timing sequences for RF “H-bridge” switch operation, such as for the switch 10 shown in FIG. 1. To simplify this first introductory description of the operation, the enable signal is assumed to be on continuously and is not shown in FIGS. 2A-2D. At time “t₁”, FIG. 2A shows the initiation of the first positive half cycle of the RF square wave from the TTL oscillator 14, followed by the initiation of the first zero half cycle at t₂ (and similarly for t₃, t₄, etc.). FIG. 2B illustrates the current flow from the 5V dc power supply through switch SB-1, then (from left to right) through the primary winding of the transformer 16, and then through switch SB-4 to ground under the “close” command signals from signal S₁ of FIG. 1 at time t₁, and then the “open” command signals from signal S₁ at time “t₂”. This current flow is shown in FIG. 2E. This process repeats at times “t₃” and “t₄,” etc. respectively, generating the positive half cycles of the RF square wave from the TTL oscillator 14.

FIG. 2C shows the initiation, just after time “t₂”, of the zero half cycle of the RF square wave from the TTL oscillator 14, followed by the initiation of the second positive half cycle of the TTL RF square wave. For this case, the current flows from the 5V dc power supply through switch SB-3, from right to left in the transformer primary winding, and then through switch SB-2 to ground under the “close” command signals from signal S₂ at time “t₂,” and then the “open” command signals from signal S₂ at time “t₃.” This current flow is also shown in FIG. 2E. This process repeats at times t₄ and t₅, etc., respectively, generating the negative half cycles of the RF square wave from the TTL oscillator 14. The Buss switches were found to be sufficiently fast in their “turn-on” and “turn-off” operation, such that this technique can be used at 100 Mz or higher frequencies.

The dotted lines of FIG. 2D illustrate a super-positioning of the square positive and the negative (i.e., the reverse current flow) portions of the waveforms of FIGS. 2B and 2C into an amplified version of the RF square wave of the TTL oscillator 14. The signal from the H-bridge 10 can be sufficient to drive subsequent semiconductor RF amplifier stages (i.e., MOSFET devices). Tuning the primary winding of the transformer 16 with a capacitor to the frequency “f” of the square wave from the TTL oscillator 14 can improve the efficiency, round off the square corners of the square wave, and provide a distorted sinusoidal waveform for amplification in the prelimary amplifier (PA) 18 of FIG. 1. This rectangular waveform is not a disadvantage because these RF power amplifiers can be driven into nonlinear output waveform operation (i.e. class C in these experiments and higher classes of non-linear operation) in order to improve the efficiency of the RF amplification process.

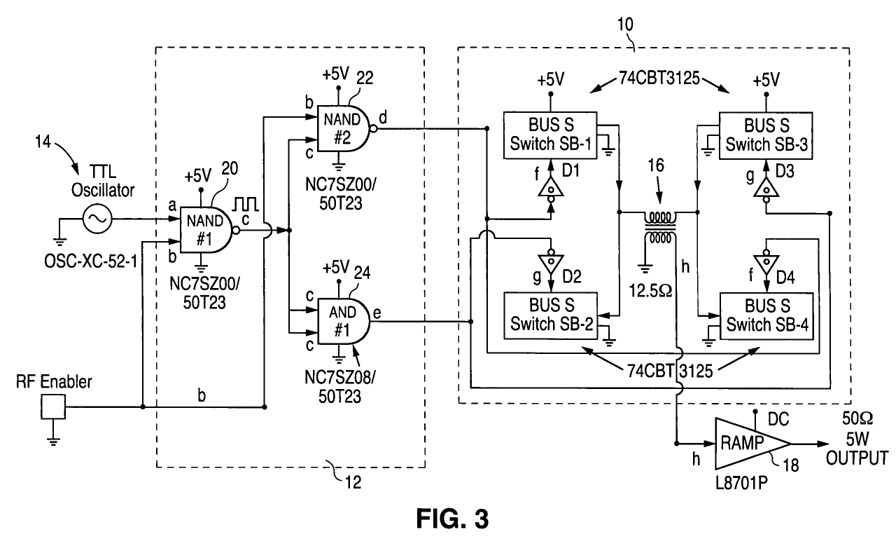

A more detailed sketch of the design of FIG. 1 is shown in FIG. 3, which includes more detail of both the digital logic circuit controller 12 and the Buss Switch RF power bridge 10. An exemplary digital logic circuit controller 12, in accordance with one embodiment of the invention, utilizes two NAND gates 20, 22 and one AND gate 24 (NAND and AND gates being well known in the art). A potential commercially available NAND chip is model NC75200/SOT23, and an AND chip is model NC75Z08/SOT23.

As is well known, a NAND gate has a “zero” output if the input is provided with two “one” values at the two input ports; for all other input conditions, a NAND gate has an output value of “one.” It is also well known that an AND gate provides an output value of “one” if the input is provided with two “one” values at the input ports; for all other input conditions, an AND gate has a “zero” output. With reference to FIG. 3 and FIGS. 4A-4H, when the output RF signals “a” from the TTL oscillator 14 and the longer duration video enabler signal “b” are both “on” and applied to the two inputs of NAND gate 20, no output signal “c” is emitted by NAND gate 20. If signal “b” is off, a signal “c” is emitted by NAND gate 20.

As an example, the timing sequences shown in FIG. 4 assume the TTL RF square wave oscillator signal “a” turns on at time “t₁” and turns off at time “t₂.” This on/off process for signal “a” can go on continuously, as shown in FIG. 4A. The sequence in FIG. 4B assumes that the square wave enabler signal “b” turns on at time t₂ and continues to time t₉, lasting for a time “T.” In this example, signal “b” encompasses four zero voltage half cycles of signal “a” and three positive voltage half cycles of signal “a.” It is understood that the enable signal may be asynchronous to the TTL oscillator 14.

As shown in FIG. 3, signal “c” and the RF enabler signal “b” are supplied to NAND gate 22, which in turn can provide signal “d” to drivers D1 and D4 (part of Buss Switches SB-1 and SB-4). The output of NAND gate 22 (i.e., signal “d”) is illustrated by FIG. 4D as a function of time, based on the time behavior of FIGS. 4B and 4C. Drivers D1 and D4 can invert the phase of signal “d,” thereby providing a signal “f” to Buss Switches SB-1 and SB-4. The time behavior of signal “f” is shown by FIG. 4F, which is shown to be inverted 180° from FIG. 4D. Signal f (as shown in FIG. 4F) causes current to flow from the 5V dc power supply, through switch SB-1, the transformer primary winding, and switch SB-4 to ground. This current flow constitutes the positive voltage half cycle portion of signal “h” out of the transformer secondary winding. A commercially available Buss Switch that has a driver D built in is model 74CBT3125. This identical Buss Switch can be used for SB-1, SB-2, SB-3 and SB-4. Drivers D1, D2, D3 and D4 can be part of the respective Buss Switches 74CBT3125, as shown in FIG. 3.

Signal “c” in FIG. 3 is also connected to both inputs of AND gate 24. AND gate 24 is used for propagation delay equalization between the “e” and the “d” signal paths of FIG. 3. At lower frequencies, AND gate 24 may not be needed. When a signal is supplied to both inputs (i.e., if signal “c” has a value of “one” in digital logic language), a signal “e” can be emitted by AND gate 24. If signal “c” is a “zero” value so that no signal is applied to the two inputs, then AND gate 24 can emit no signal (i.e., emits a “zero).

FIG. 4E illustrates the time sequence of signal “c” and the corresponding time sequence of signal “e” emitted by AND gate 24. FIG. 4G shows the inversion of signal “e” after it passes through drivers D3 and D4. At time “t₃” of FIG. 4G, signal “g” is “on” and turns on Buss Switches SB-4 and SB-2, causing current to flow from the +5V dc supply, through switch SB-3, from right to left through the transformer primary winding, then through switch SB-2 to ground. This current flow generates the negative half cycle of signal “h”, as shown in FIG. 4H. This process continues for signals “f” and “g” (i.e., FIGS. 4F and 4G) until enabler signal “b”, illustrated by FIG. 4B, is turned off at time “t₉”. When signal “b” is turned off at time “t₉”, signal “h” out of the transformer secondary winding is also turned off. This is how the enabler signal provides pulse width modulation of the RF power supply output, which in turn changes the average output power of the laser. The inverse of the duty cycle (i.e., ratio of on to off time) specified by signal “b”, as illustrated by FIG. 4B, establishes the amount of increase in peak power over the CW power that the RF power supply can provide to the laser discharge while maintaining the same average laser power output. For some material processing applications, this so called “super pulsed” operational capability is important.

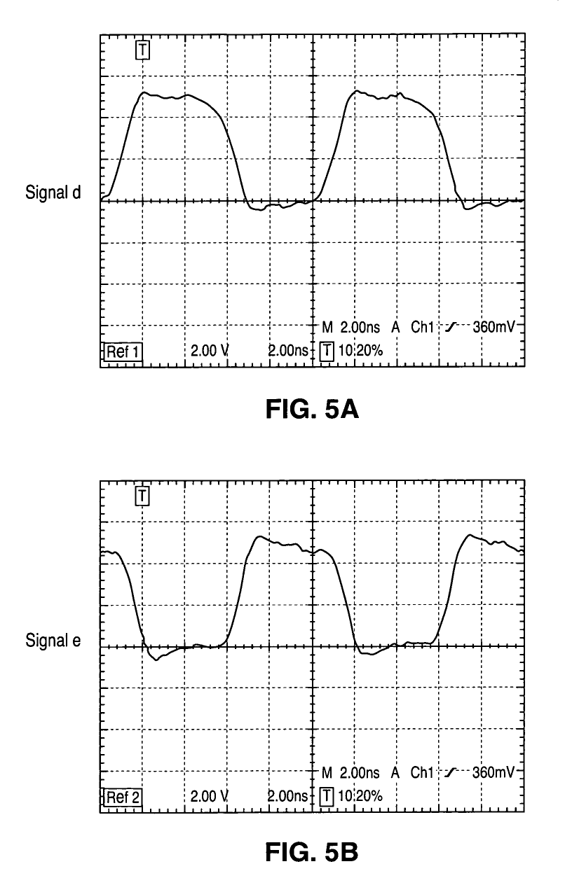

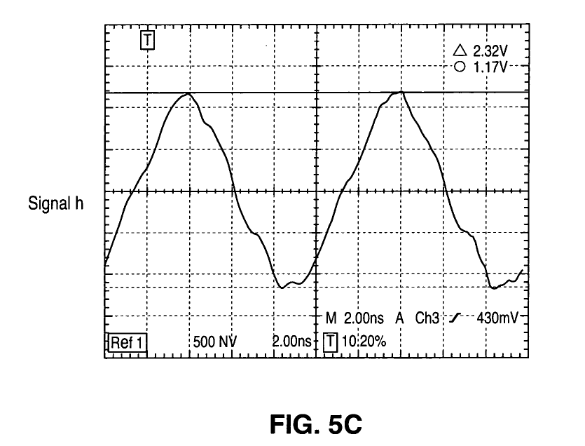

FIGS. 5A and 5B illustrate oscilloscope waveforms of signals “d” and “e,” respectively, of FIG. 3 and FIGS. 4A-4H operating at 100 MHz. The corresponding distorted waveform (i.e., signal “h”) out of the secondary winding of the transformer of FIG. 3 is shown by FIG. 5C. This signal is provided to the preamplifier 18 of FIG. 3. Operation up to 160 MHz and higher is possible using such an H-power bridge concept.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A system for providing an RF power signal, the system comprising:
an oscillator device that provides an oscillator output signal at a selected RF frequency;
a controller device that receives the oscillator output signal and generates first and second controller output signals in response thereto;
an “H” power bridge that is controlled by the first controller output signal to be in a first active state configuration and is controlled by the second output controller output signal to be in a second active state configuration; and
a transformer connected to “H” power bridge such that, when the “H” power bridge is in the first active state configuration, current flows through the transformer in a first direction, and when the “H” power bridge is in the second active state configuration, current flows through the transformer in a second direction, whereby the transformer generates an output RF signal.

2. A system as in claim 1, and wherein the selected RF frequency is in the range of about 500 KHz to about 125 MHz.

3. A system as in claim 1, and wherein the “H” power bridge is connected to a dc power supply.

4. A system as in claim 3, and wherein the dc power supply is a 5V supply.

5. A system as in claim 1, and further comprising:
an amplifier connected to receive the output RF signal from the transformer and provide an amplified RF signal corresponding thereto.

6. A system as in claim 1, and wherein the output RF signal is about 56 mW.

7. A system for generating an RF power signal, the system comprising:
a dc power supply;
a transformer having primary windings and secondary windings, the primary windings having a first end and a second end, the secondary windings having a first end connected to ground and a second end connected to a transformer output node;
a crystal controlled TTL oscillator that provides an RF periodic wave output signal having a selected frequency;
a digital logic controller that responds to the oscillator output signal by providing controller output signals; and
an “H” power bridge connected to receive control signals from the digital logic controller, the “H” bridge including a first switch connected between the dc power supply and the first end of the primary windings of the transformer, a second switch connected between the first end of the primary windings of the transformer and ground, a third switch connected between the dc power supply and the second end of the primary windings of the transformer, and a fourth switch connected between the second end of the primary windings of the transformer and ground,
the digital logic controller providing a first control signal during a first half cycle of the oscillator output signal, the first control signaling causing the first and fourth switches of the “H” power bridge to be closed and the second and third switches of the “H” power bridge to be open such that the transformer provides a first current output to the transformer output node that approximately reproduces the square wave oscillator output during the first half cycle of the oscillator output signal,
the digital logic controller providing a second control signal during a second half cycle of the oscillator output signal, the second control signal causing the first and fourth switches of the “H” power bridge to be open and the second and third switches of the “H” power bridge to be closed such that the transformer provides a second current output to the transformer output node that approximately reproduces the square wave oscillator output during the second half cycle of the of the oscillator output signal,
whereby the transformer output node provides an RF output signal.

8. A system as in claim 7, and further comprising:
an amplifier connected to the transformer output node for receiving the RF output signal and for generating an amplified RF signal corresponding thereto.

9. A system as in claim 7, and wherein the each of the first, second, third and fourth switches comprises a buss switch.

10. A system as in claim 7, and further comprising:
an enabler signal provided to the digital logic controller for pulse-width modulating the controller output signals.

11. A system as in claim 10, and wherein the digital logic controller comprises:
a first NAND gate having an output node and connected to receive the oscillator output signal and the enabler signal as inputs;
a second NAND gate having an output node and connected to receive an output of the first NAND gate and the enabler signal as inputs, the output node of the second NAND gate connected to provide the first control signal; and
an AND having and output node and first and second inputs connected to the output node of the first NAND gate, the output node of the AND gate connected to provide the second control signal.

12. A method for providing RF power, comprising the steps of:
generating an oscillator signal having a selected RF frequency;
providing the oscillator signal to a logic device and generating first and second control signals in response thereto; and
providing the first and second control signals to a plurality of switches arranged in an “H” bridge configuration, wherein an active state of a first two of the switches is controlled by the first control signal and an active state of a second two of the switches is controlled by the second control signal, the “H”-bridge configuration having a transformer connected to the plurality of switches such that, when the first two of the switches are in an active state, current flows through the transformer in a first direction, and when the second two of the switches are in an active state, current flows through the transformer in a second direction, the transformer generating an output RF signal.

13. A method as in claim 12, and further comprising:
providing the output RF signal to an amplifier for generating an amplified RF signal.

14. A method as in claim 12, and wherein the selected frequency is about 100 MHz.

15. A method as in claim 12, and further comprising:
providing an enabler signal to the logic device for pulse width modulating the oscillator signal.

16. A method for providing RF power, the method comprising:
generating a signal at a selected RF frequency;
providing the signal to a logic device that generates first and second output signals in response thereto; and
providing the first and second output signals to a plurality of switches arranged in an “H” bridge configuration, wherein the active state of a first two of the switches is controlled by the first output signal and an active state of a second two of the switches is controlled by the second output signal, the “H” bridge configuration having a transformer connected to the plurality of switches such that when the first two switches are in an active state, current flows through the transformer in a first direction, and when the second two of the switches are in an active state, current flows through the transformer in a second direction, the transformer generator an output RF signal.

17. A method as in claim 16, and further comprising:
providing the output RF signal to an amplifier that generates an amplified RF signal.

18. A method as in claim 16, and further comprising:
providing an enabler signal to the logic device for pulse width modulating the signal.

19. A system for providing an RF power signal, the system comprising:
an oscillator that provides an oscillator output signal;
an “H” power bridge that includes a plurality of switches and is responsive to first and second power bridge input signals to be in first and second active state configurations, respectively;
a control system responds to an input enable signal to gate the oscillator output signal on and off to provide the first and second power bridge input signals, respectively, such that when the oscillator output signal is gated off, the plurality of switches in the “H” power bridge are off; and
a transformer connected to the “H” power bridge such that, when the “H” power bridge is in the first active state configuration, current flows through the transformer in a first direction, and when the “H” power bridge is in the second active state configuration, current flows through the transformer in a second direction, whereby the output RF signal is generated.
